(19) United States
(12) Patent Application Publication
(10) Pub. No.: US 2018/0324656 A1
(43) Pub. Date: Nov. 8, 2018

(54) CELL RESELECTION METHOD AND APPRATUS

(71) Applicant: CHINA MOBILE COMMUNICATIONS GROUP CO., LTD., Beijing (CN)

(72) Inventors: Ningyu Chen, Beijing (CN); Zhuo Chen, Beijing (CN); Nan Hu, Beijing (CN)

(21) Appl. No.: 15/772,095

(22) PCT Filed: Sep. 6, 2016
(86) PCT No.: PCT/CN2016/098209

§ 371 Date: Apr. 30, 2018

(30) Foreign Application Priority Data
Nov. 3, 2015 (CN) 201510744582.9

(51) Int. Cl. H04W 36/00; H04W 48/20; H04W 36/08; H04W 36/30

(52) U.S. Cl. CPC H04W 36/0083; H04W 36/30; H04W 36/08; H04W 48/20

(57) ABSTRACT

The present disclosure provides a cell reselection method and apparatus. The cell reselection method comprises: after a terminal sends a first access request or the first access request is blocked for preset times, separately obtaining a first block parameter of a serving cell and a second block parameter of a neighboring cell of the serving cell, the first access request being an access request for a target service or application; generating offset parameter information corresponding to the target service or application according to the first block parameter and the second block parameter, the offset parameter information comprising: information about first duration for which the target service or application needs to wait to access the serving cell and information about second duration for which the target service or application needs to wait to access the neighboring cell; and applying the offset parameter information to a cell reselection rule R, and determining a target cell to camp on.

### CROSS-REFERENCE TO RELATED APPLICATIONS

The present application claims priority to Chinese Patent Application No. 201510744582.9, filed on Nov. 3, 2015, the contents of which are hereby incorporated by reference in its entirety.

### TECHNICAL FIELD

The disclosure relates to the technical field of cell reselection, and particularly to a cell reselection method and device.

### BACKGROUND

Existing cell reselection is based on cell signal quality detected by User Equipment (UE), which does not take a type of a service/application currently requested to be initiated by the UE into account, nor an access priority of this service/application in surrounding cells. The UE may always reselect to cells with better signal quality, but these cells are very likely to have no sufficient resources to support the service/application currently requested to be initiated by the UE. This will cause the UE to have multiple access failures in such cells.

### SUMMARY

The disclosure is intended to provide a cell reselection method and device, which are adopted to solve the problem that after a service or application initiated by a UE is barred, the UE cannot reselect to cell suitable for the service or application by an existing cell reselection mechanism.

In order to achieve the purpose, the disclosure provides a cell reselection method, which may be applied to UE, the cell reselection method comprises that:

after the UE sends a first access request or the first access request is barred for a predetermined number of times, a first barring parameter of a serving cell and a second barring parameter of a neighbor cell of the serving cell are acquired, the first access request being a request for accessing a target service or application;

offset parameter information corresponding to the target service or application is generated according to the first barring parameter and the second barring parameter, the offset parameter information comprising: first time information indicating a time period for which the target service or application is required to wait for access to the serving cell and second time information indicating a time period for which the target service or application is required to wait for access to the neighbor cell; and

the offset parameter information is applied to a cell reselection R criterion, and a target cell for camping on is determined.

Herein, after the operation that the offset parameter information is applied to the cell reselection R criterion and the target cell for camping on is determined, the cell reselection method may further comprise that:

whether a second access request for the target service or application is sent or not is judged within a first predetermined time after camping on the target cell;

if the second access request is sent within the first predetermined time and no access request for the target service or application is sent within a second predetermined time after finishing an indication operation corresponding to the second access request, it is determined that the offset parameter information gets invalid; and

if the second access request is not sent within the first predetermined time, it is determined that the offset parameter information gets invalid.

Herein, the step that the second barring parameter of the neighbor cell of the serving cell is acquired may comprise hat:

the second barring parameter, broadcast by a base station of which the serving cell is under coverage, of the neighbor cell is received, wherein the second barring parameter may be an Application specific Congestion control for Data Communication (ACDC) barring parameter of the neighbor cell; or,

a Master Information Block (MIB) message of the neighbor cell is acquired, and analysis and processing is performed on a System Information Block (SIB) message according to the MIB message to obtain the second barring parameter of the neighbor cell, wherein the second barring parameter may be the ACDC barring parameter of the neighbor cell.

Herein, the operation that the offset parameter information corresponding to the target service or application is generated according to the first barring parameter and the second barring parameter may comprise that:

a first ACDC class corresponding to the target service or application in the serving cell and a second ACDC class corresponding to the target service or application in the neighbor cell are acquired;

a barring parameter in the first ACDC class is taken as the first barring parameter, wherein information of the first barring parameter may comprise: a barring probability Pbarₛ of the serving cell and a barring time Tbarₛ of the serving cell;

a barring parameter in the second ACDC class is taken as the second barring parameter, wherein information of the second barring parameter may comprise: a barring probability Pbarₙ of the neighbor cell and a barring time Tbarₙ of the neighbor cell; and

the offset parameter information is generated through formulae Q_{ACDC,s}=α×(1−Pbarₛ)×Tbarₛ and Q_{ACDC,n}=α×(1−Pbarₙ)×Tbarₙ, α representing a preset adjustment parameter, Q_{ACDC,s} representing the first time information and Q_{ACDC,n} representing the second time information.

Herein, the operation that the offset parameter information corresponding to the target service or application is generated according to the first barring parameter and the second barring parameter may comprise that:

barring parameters in all ACDC classes of the serving cell are acquired, and the barring parameters in all the ACDC classes of the serving cell are taken as the first barring parameter;

barring parameters in all ACDC classes of the neighbor cell are acquired, and the barring parameters in all the ACDC classes of the neighbor cell are taken as the second barring parameter;

the first time information is generated through a formula Q_{ACDC,s}=α₁×(1−Pbar₁)×Tbar₁+α₂×(1−Pbar₂)×Tbar₂+ . . . +αₙ×(1−Pbarₙ)×Tbarₙ, where Q_{ACDC,s} may represent the first time information, Pbarₙ may represent a barring probability of the nth ACDC class of the serving cell, Tbarₙ may represent a barring time of the nth ACDC class of the serving cell, and αₙ may represent a weighted value of the nth ACDC class of the serving cell; and

the second time information is generated through a formula Q_{ACDC, n}=α₁×(1−Pbar₁)×Tbar₁+α₂×(1−Pbar₂)×Tbar₂+ . . . +α₁×(1−Pbarᵢ)×Tbarᵢ, where Q_{ACDC,n} may represent the second time information, Pbarᵢ may represent a barring probability of the ith ACDC class of the neighbor cell, Tbarᵢ may represent a barring time of the ith ACDC class of the neighbor cell, and αᵢ may represent a weighted value of the ith ACDC class of the neighbor cell.

Herein, the operation that the offset parameter information is applied to the cell reselection R criterion and the target cell for camping on is determined may comprise that:

a value of R of the serving cell is acquired through a formula Rₛ=Q_{mea,s}+Q_{Hyst}−Q_{offsettemp}−Q_{ACDC,s}, where Rₛ may represent the value of R of the serving cell, Q_{mean,s} may represent Reference Signal Receiving Power (RSRP) for cell reselection, Q_{Hyst} may represent a reselection hysteresis parameter of the serving cell, Q_{offsettemp} may represent a new offset parameter in the cell reselection R criterion, and Q_{ACDC,s} may represent the first time information;

a value of R of the neighbor cell is acquired through a formula Rₙ=Q_{meas,n}−Q_{offset}−Q_{offsettemp}−Q_{ACDC,n}, where Rₙ may represent the value of R of the neighbor cell, Q_{mean,n} may represent the RSRP for cell reselection, Q_{offset} may represent an offset value of the neighbor cell, Q_{offsettemp} may represent the new offset parameter in the cell reselection R criterion, and Q_{ACDC,n} may represent the second time information; and

a cell with a maximum value of R is selected from the serving cell and the neighbor cell as the target cell.

The disclosure further provides a cell reselection device, which may be applied to UE, the cell reselection device comprising:

an acquisition module, configured to, after the UE sends a first access request or the first access request is barred for a predetermined number of times, acquire a first barring parameter of a serving cell and a second barring parameter of a neighbor cell of the serving cell, the first access request being a request for accessing a target service or application;

a generation module, configured to generate offset parameter information corresponding to the target service or application according to the first barring parameter and the second barring parameter, the offset parameter information including: first time information indicating a time period for which the target service or application is required to wait for access to the serving cell and second time information indicating a time period for which the target service or application is required to wait for access to the neighbor cell; and

a first determination module, configured to apply the offset parameter information to a cell reselection R criterion and determine a target cell for camping on.

Herein, the cell reselection device may further comprise:

a judgment module, configured to judge whether a second access request for the target service or application is sent or not within a first predetermined time after camping on the target cell;

a second determination module, configured to, if the second access request is sent within the first predetermined time and no access request for the target service or application is sent within a second predetermined time after finishing an indication operation corresponding to the second access request, determine that the offset parameter information gets invalid; and

a third determination module, configured to, if the second access request is not sent within the first predetermined time, determine that the offset parameter information gets invalid.

Herein, the acquisition module may comprise:

a receiving unit, configured to receive the second barring parameter, broadcast by a base station of which the serving cell is under coverage, of the neighbor cell, wherein the second barring parameter may be an ACDC barring parameter of the neighbor cell; or,

a first acquisition unit, configured to acquire an MIB message of the neighbor cell, and perform analysis and processing on an SIB message according to the MIB message to obtain the second barring parameter of the neighbor cell, wherein the second barring parameter may be the ACDC barring parameter of the neighbor cell.

Herein, the generation module may comprise:

a second acquisition unit, configured to acquire first ACDC class corresponding to the target service or application in the serving cell and a second ACDC class corresponding to the target service or application in the neighbor cell;

a first processing unit, configured to take a barring parameter in the first ACDC class as the first barring parameter, wherein information of the first barring parameter may comprise: a barring probability Pbarₛ of the serving cell and a barring time Tbarₛ of the serving cell;

a second processing unit, configured to take a barring parameter in the second ACDC class as the second barring parameter, wherein information of the second barring parameter may comprise: a barring probability Pbarₙ of the neighbor cell and a barring time Tbarₙ of the neighbor cell; and

a first generation unit, configured to generate the offset parameter information through formulae Q_{ACDC,s}=α×(1−Pbarₛ)×Tbarₛ and Q_{ACDC,n}=α×(1−Pbarₙ)×Tbarₙ, α representing a preset regulation parameter, Q_{ACDC,s} representing the first time information and Q_{ACDC,n} representing the second time information.

Herein, the generation module may further comprise:

a third acquisition unit, configured to acquire barring parameters in all ACDC classes of the serving cell, and take the barring parameters in all the ACDC classes of the serving cell as the first barring parameter;

a fourth acquisition unit, configured to acquire barring parameters in all ACDC classes of the neighbor cell, and take the barring parameters in all the ACDC classes of the neighbor cell as the second barring parameter;

a second generation unit, configured to generate the first time information through a formula Q_{ACDC, s}=α₁×(1−Pbar₁)×Tbar₁+α₂×(1−Pbar₂)×Tbar₂+ . . . +αₙ×(1−Pbarₙ)×Tbarₙ, where Q_{ACDC,s} may represent the first time information, Pbarₙ may represent a barring probability of the nth ACDC class of the serving cell, Tbarₙ may represent a barring time of the nth ACDC class of the serving cell, and αₙ may represent a weighted value of the nth ACDC class of the serving cell; and

a third generation unit, configured to generate the second time information through a formula Q_{ACDC,n}=α₁×(1−Pbar₁)×Tbar₁+α₂×(1−Pbar₂)×Tbar₂+ . . . +α₁×(1−Pbarᵢ)×Tbarᵢ, where Q_{ACDC,n} may represent the second time information, Pbarᵢ may represent a barring probability of the ith ACDC class of the neighbor cell, Tbarᵢ may represent a barring time of the ith ACDC class of the neighbor cell, and αᵢ may represent a weighted value of the ith ACDC class of the neighbor cell.

Herein, the first determination module may comprise:

a fifth acquisition unit, configured to acquire a value of R of the serving cell through a formula R_{d}=Q_{meas,s}++Q_{Hyst}−Q_{offsettemp}−Q_{ACDC,s}, where Rₛ may represent the value of R of the serving cell, Q_{mean,s} may represent RSRP for cell reselection, Q_{Hyst} may represent a reselection hysteresis parameter of the serving cell, Q_{offsettemp} may represent a new offset parameter in the cell reselection R criterion, and Q_{ACDC,s} may represent the first time information;

a sixth acquisition unit, configured to acquire a value of R of the neighbor cell through a formula Rₙ=Q_{meas,n}−Q_{offset}−Q_{offsettemp}−Q_{ACDC,n}, where Rₙ may represent the value of R of the neighbor cell, Q_{mean,n} may represent the RSRP for cell reselection, Q_{offset} may represent an offset value of the neighbor cell, Q_{offsettemp} may represent the new offset parameter in the cell reselection R criterion, and Q_{ACDC,n} may represent the second time information; and

a determination unit, configured to select a cell with a maximum value of R from the serving cell and the neighbor cell as the target cell.

Embodiments of the disclosure have the following beneficial effects.

According to the cell reselection method of the embodiments of the disclosure, after the UE sends the first access request or the first access request is barred for a predetermined number of times, the first barring parameter of the serving cell and the second barring parameter of the neighbor cell of the serving cell are acquired; the offset parameter information corresponding to the target service or application is generated according to the first barring parameter and the second barring parameter; and the offset parameter information is applied to the cell reselection R criterion, and a target cell for camping on is determined. According to the embodiments of the disclosure, the offset parameter information is applied to the cell reselection R criterion for reselection of the cell suitable for the target service or application, so that a waiting time for access to the target service or application is reduced, and an access success rate of the target service or application is improved.

### BRIEF DESCRIPTION OF DRAWINGS

FIG. 1 is a schematic diagram of a cell deployment structure according to an embodiment of the disclosure.

FIG. 2 is a first working flowchart of a cell reselection method according to an embodiment of the disclosure.

FIG. 3 is a second working flowchart of a cell reselection method according to an embodiment of the disclosure.

FIG. 4 is a third working flowchart of a cell reselection method according to an embodiment of the disclosure.

FIG. 5 is a fourth working flowchart of a cell reselection method according to an embodiment of the disclosure.

FIG. 6 is a structure block diagram of a cell reselection device according to an embodiment of the disclosure.

### DETAILED DESCRIPTION

For making the technical problem to be solved, technical solutions and advantages of the disclosure clearer, detailed descriptions will be made below in combination with specific embodiments and the drawings.

The embodiments of the disclosure provide a cell reselection method and device, so as to solve the problem that after a service or application initiated by a UE is barred, the UE cannot reselect to cell suitable for the service or application by an existing cell reselection mechanism.

The disclosure is ACDC-technology-based enhancement to a cell reselection technology. In order to enable those skilled in the art to better understand the cell reselection process in the embodiments of the disclosure, an ACDC technology and a cell reselection technology will be explained and described below respectively.

(I) The ACDC Technology

ACDC, an abbreviation of “Application specific Congestion control for Data Communication”, is an access control mechanism, and an operator may allow or bar an access request for specific application software when the UE is in an idle state. ACDC is not applicable to UE in a connected state but only to UE in an idle state, and its function is to prevent an access network or a core network from being overloaded.

ACDC has the following basic characteristics:

1. ACDC is applicable to Universal Mobile Telecommunications System (UMTS) Terrestrial Radio Access Network (UTRAN) and an Evolved UTRAN (E-UTRAN). A home network configures at least four ACDC classes for UE, corresponding to applications defined by an operator respectively.

2. Fulfilling the ACDC classes in the UE is a responsibility of the home network, and how to classify is not defined by the 3rd Generation Partnership Project (3GPP).

3. The UE has a set of mechanism for verifying that it is a trusted source fulfilling the ACDC classes for it.

4. A serving network broadcasts control information on an access network side, the control information may comprise: barring information of each ACDC class and information indicating that whether a roaming UE should be limited by ACDC or not.

5. Barring information broadcast in each cell is different, and a corresponding relationship between an application and ACDC class in the UE is configured by the home network.

6. On the basis of the broadcast barring information and an ACDC class configuration in the UE, the UE may determine whether to allow an access request for a specific application to be transmitted or not.

7. The service network should indicate ACDC at the same time of executing other access control, and when ACDC and Access Class Barring (ACB) control are indicated at the same time, ACDC should cover ACB.

8. When a same access network is shared by multiple core networks, the access network should be able to independently execute ACDC for different core networks respectively. For alleviating congestion of a shared access network, a barring ratio should be set to be the same for different operators.

The ACDC class configuration will be specifically described below.

An operating system of the UE assigns an application software Identifier (id) to each piece of application software, and the UE obtains a corresponding relationship between an application software id and an ACDC class by receiving broadcast of the home network or by virtue of writing of a remote Subscriber Identity Module (SIM) card of a core network. Multiple different application software ids may correspond to a same ACDC class.

The home network configures ACDC classes for the UE's application:

1. For an application which is restricted least (with a highest access priority), a highest ACDC class, i.e., ACDC#1, is configured;

2. For an application which is restricted more than ACDC#1, a second highest ACDC class, i.e., ACDC#2, is configured, and so on; and

3. For an application which is restricted most (with a lowest access priority), a lowest ACDC class is configured, or no ACDC class is configured.

The application configured with no ACDC class on the UE should be considered by the UE to belong to the lowest ACDC class. When ACDC is used, the serving network broadcasts the barring information, and the barring information is sequentially sent from the highest ACDC class to the lowest ACDC class. The home network and the serving network may use different classification methods. The serving network determines whether to apply ACDC to the roaming UE.

A number of the ACDC classes on the UE may be different from a number of ACDC classes broadcast by the serving network. This case may occur when the UE roams, and the number of the ACDC classes broadcast by the serving network is different from the number of the ACDC classes configured by the home network of the UE. Therefore, the following strategies are adopted at this moment:

1. If the number of the ACDC classes broadcast by the serving network is more than those configured for the UE, the UE uses the barring information corresponding to the configured ACDC classes, adopts the barring information of the lowest class broadcast by a serving cell for the application which is not classified, and ignores the other barring information mismatched with its own ACDC classes.

2. If the number of the ACDC classes corresponding to the barring information broadcast by the serving network is smaller than those configured for the UE, the UE adopts the corresponding barring information for the matched ACDC classes, and adopts the barring information of the lowest class in the serving cell for other applications.

In addition, a matched ACDC class refers to that an ACDC class sequence of the barring information broadcast by the serving network is the same as an ACDC class sequence configured for the UE.

Then, ACDC barring parameters in the serving network will be specifically described.

The ACDC barring parameters broadcast by the network may adopt two forms, the first is barring parameters similar to ACB, and the second is barring parameters similar to Extended Access Barring (EAB).

(1) The Barring Parameters Similar to ACB

The serving network sequentially broadcasts ACDC barring parameters of different classes, including “barring time” and a “barring probability”.

The barring time: if an ACDC class corresponding to application software a is #1 and barring time of broadcast ACDC#1 is Tbar=100 ms, a connection request for the application software a may always be barred within a time Tbar or a time (Tbar+random number) once the connection request for the application software a is barred by an ACDC strategy.

The barring probability: if an ACDC class corresponding to application software b is #2 and a barring probability of broadcast ACDC#2 is Pbar=0.6, when the application software b initiates a connection request, the UE generates a random number between 0 and 1 for the application software b, if the random number is less than or equal to 0.6, access is allowed, and if the random number is more than 0.6, access is rejected.

(2) The Barring Parameters Similar to EAB

As shown in Table 1, the home network randomly divides the UE into 10 different Access Class (AC) groups, i.e., AC0, AC1, AC2 . . . AC9. The serving network broadcasts ACDC barring parameters, the ACDC barring parameters similar to EAB are shown as follows, and for each AC group of each ACDC class, number “1” represents that access is allowed, and number “0” represents that access is forbidden. For example, application software “Fetion” belongs to an ACDC class 2, and if a UE belonging to AC4 is intended to initiate the application “Fetion”, an ACDC barring parameter broadcast by the network may be queried to be looked up, as shown in the table, that a value is “0”, then access is forbidden, and the application is barred. Moreover, no more access is allowed to be initiated within a time specified by the system.

TABLE 1

| | AC0 | AC1 | AC2 | AC3 | AC4 | AC5 | AC6 | AC7 | AC8 | AC9 |
|---|---|---|---|---|---|---|---|---|---|---|
| ACDC | 1 | 1 | 1 | 1 | 1 | 1 | 1 | 0 | 0 | 1 |
| #1 | | | | | | | | | | |
| ACDC | 1 | 0 | 1 | 1 | 0 | 1 | 0 | 1 | 1 | 1 |
| #2 | | | | | | | | | | |
| ACDC | 0 | 1 | 1 | 0 | 1 | 0 | 1 | 1 | 1 | 0 |
| #3 | | | | | | | | | | |
| ACDC | 0 | 1 | 0 | 0 | 1 | 0 | 1 | 0 | 0 | 1 |
| #4 | | | | | | | | | | |

In the specific embodiments of the disclosure, for the barring parameters similar to EAB, parameters of the “barring time” and the “barring probability” may be calculated, the “barring time” is a waiting time after barring and is configured by the system, and the “barring probability” of each ACDC class may be calculated by a proportion of 1 in the above Table 1. For example, in the above table, in ACDC#1, the number of ‘1’ is 8, the number of ‘0’ is 2, and then the “barring probability” is 0.8.

(II) The Cell Reselection Technology

(1) The Purpose of Cell Reselection

A random access load between different frequency points is balanced, and when being required to camp on cells, UE is uniformly distributed as much as possible.

(2) Implementation Method

A network side: different frequency point priorities are set.

A UE side: after a cell is selected, UE in an idle state continues performing cell reselection to camp on a cell with a higher priority or better channel quality.

(3) Cell Reselection Criterion-R Criterion

Rₛ=Q_{meas,s}+Q_{Hyst}−Q_{offsettemp}, and

Rₙ=Q_{meas,n}−Q_{offset}−Q_{offsettemp},

where Rₛ represents a value of R of a serving cell; Rₙ represents a value of R of a neighbor cell; Q_{mean,s} represents Reference Signal Receiving Power (RSRP) for cell reselection; Q_{Hyst} represents a reselection hysteresis parameter of the serving cell and is included in a broadcast system message SIB3; Q_{offsettemp} represents a new offset parameter in the cell reelection R criterion; and Q_{offset} represents an offset value of the neighbor cell and is included in a broadcast system message SIB4. For intra-frequency reselection, Q_{offset} is equal to inter-cell Q_{offset} (it is 0 if not existing in a system broadcast), and for inter-frequency reselection, Q_{offset} is equal to inter-frequency Q_{offset} plus inter-cell Q_{offset}. Q_{offsettemp} represents the new offset parameter in the cell reselection R criterion, and if the UE fails in random access for many times in the cell, this offset is added. A timer is set, and after a timeout, the offset gets invalid.

(4) Implementation of the Cell Reselection Criterion-R Criterion

Cell reselection may be divided into intra-frequency cell reselection and inter-frequency cell reselection. A main purpose of intra-frequency cell reselection is to solve a wireless coverage problem; and inter-frequency cell reselection may not only be adopted to solve the wireless coverage problem, but also may be adopted for load balancing.

Intra-Frequency Reselection Process:

A value of S of the serving cell and Sintra-search in the system broadcast are compared to determine whether to perform intra-frequency measurement or not;

Candidate cells are ordered by using R criterion according to channel quality thereof, and an optimal cell is selected; and

whether the optimal cell is a suitable cell or not is determined according to a suitable cell criterion.

Inter-Frequency Reselection Process:

1. Measurement: the UE always measures frequencies with a higher priority in an SIB, and when a value of S of the serving cell is less than a threshold, frequencies with a lower priority are simultaneously measured;

2. Priority processing: frequency point priority information is from a broadcast message and a Radio Resource Control (RRC) connection release message; and

3. Reselection: for the frequencies with the higher priority, if the value of S is greater than the threshold, the optimal cell is selected according to the R criterion, and if there is no cell meeting a requirement at the frequencies with the higher priority and the value of S of the serving cell is less than the threshold, reselection at the frequencies with the lower priority is started.

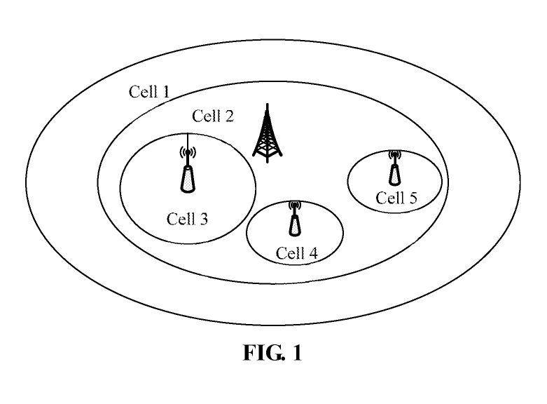

Then, an application scenario of the embodiments of the disclosure will be specifically described. The embodiments of the disclosure are applied to an overlapping coverage scenario. As shown in FIG. 1, a frequency band (or cell) 1 implements broad coverage, and a frequency band (or cell) 2 implements a shunting of a large-data-volume service. For avoiding excessive handover or reselection of UE, the UE may usually camp on the cell 1. However, a broadband multimedia service may be barred in the cell 1. The UE may reselect to the cell 2 if being intended to initiate the large-data-volume service, and may return to the cell 1 after the service is finished.

A conventional art has the following shortcomings: existing cell reselection is based on cell signal quality detected by UE, which does not take a type of a service/application currently requested to be initiated by the UE into account, nor an access priority to this service/application in surrounding cells. The UE may always reselect to cells with better signal quality, but these cells are very likely to have no sufficient resources to support the service/application currently requested to be initiated by the UE. This will cause the UE to have multiple access failures in such cells. When a certain service or application initiated by the UE is barred but the service is barred less by a neighbor cell with overlapping coverage, an existing cell reselection mechanism cannot make the UE reselect to a cell more suitable for the service or application of the UE.

### First Embodiment

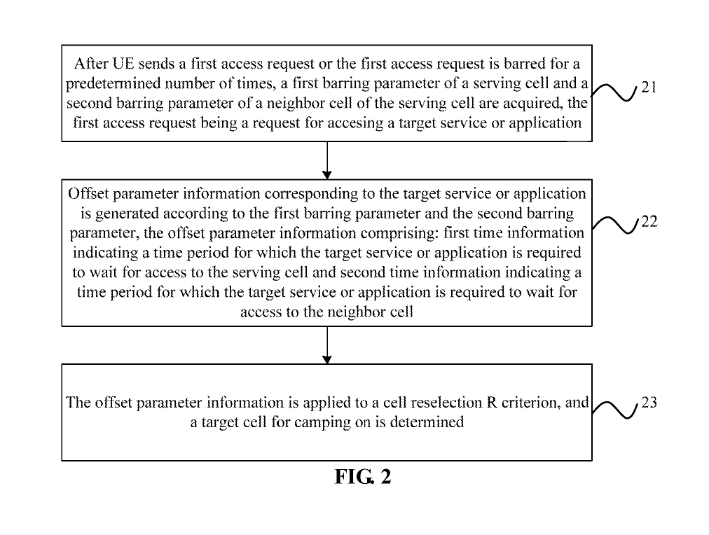

As shown in FIG. 2, a cell reselection method of the embodiment comprises the following steps.

In 21, after UE sends a first access request or the first access request is barred for a predetermined number of times, a first barring parameter of a serving cell and a second barring parameter of a neighbor cell of the serving cell are acquired, the first access request being a request for accessing a target service or application.

Here, the first barring parameter is specifically an ACDC barring parameter of the serving cell, and the second barring parameter is specifically an ACDC barring parameter of the neighbor cell. The target service may specifically be a voice service, a short message service, a video call service, a multimedia service and the like, and the target application may specifically be the WeChat application, a video application, the Fetion application and the like.

When the UE initiates an access request for an application or a service, ACDC judgment is executed at first. If the judgment succeeds, a connection is established with a base station, and information is transmitted. If the judgment fails, the application is not allowed to send any other access requests within a time Tbar. After the access request for the application is continuously barred for N times, cell reselection is triggered, and the UE performs neighbor cell measurement, receives a system broadcast of the neighbor cell, and reads an ACDC barring parameter of the neighbor cell. Alternatively, when the UE initiates a access request for an application or a service, cell reselection is triggered, and the UE performs neighbor cell measurement, receives the system broadcast of the neighbor cell, and reads the ACDC barring parameter of the neighbor cell. In addition, an ACDC parameter of the serving cell may specifically be acquired from a local storage space by the UE.

Specifically, the UE may acquire the barring parameter of the neighbor cell in the following two manners. (1) The serving cell acquires the barring parameter of the neighbor cell and transmits it to the UE. Each cell sends own barring parameter to all cells in a neighbor cell list through an X interface, the current cell broadcasts the barring parameter of the neighbor cell through a system message after receiving the barring parameter from the neighbor cell, and after receiving the barring parameter of the neighbor cell, broadcast by the base station of which the serving cell is under coverage, the UE stores the barring parameter of the neighbor cell, the barring parameter of the neighbor cell is used for generating of offset parameter information. (2) The UE actively listens to the system message of the neighbor cell. UE camping on a cell A may periodically listen to system messages of neighbor cells B, C, D and the like. A specific listening manner is that: the UE is synchronized with the neighbor cell B, acquires an MIB, parses an SIB, acquires a barring parameter of the neighbor cell, and sequentially perform the operations to acquire barring parameters of the cells C and D.

In 22, offset parameter information corresponding to the target service or application is generated according to the first barring parameter and the second barring parameter, the offset parameter information including: first time information indicating a time period for which the target service or application is required to wait for access to the serving cell and second time information indicating a time period for which the target service or application is required to wait for access to the neighbor cell.

In the specific embodiment of the disclosure, the offset parameter information configured to represent a time for which the target service or application is required to wait for access to a cell is obtained according to the first barring parameter and the second barring parameter, so that a cell requiring a shorter waiting time for access may be selected according to the offset parameter information, the phenomenon that the UE fails in access for many times in a cell with better signal quality may be prevented, and an access success rate is improved.

In 23, the offset parameter information is applied to a cell reselection R criterion, and a target cell for camping on is determined.

According to the cell reselection method of the embodiment of the disclosure, the offset parameter information is applied to the cell reselection R criterion, values of R of the serving cell and the neighbor cell are calculated, and a cell suitable for the target service or application is reselected according to the values of R, so that the waiting time for accessing to the target service or application is shortened, and the access success rate of the target service or application is improved.

### Second Embodiment

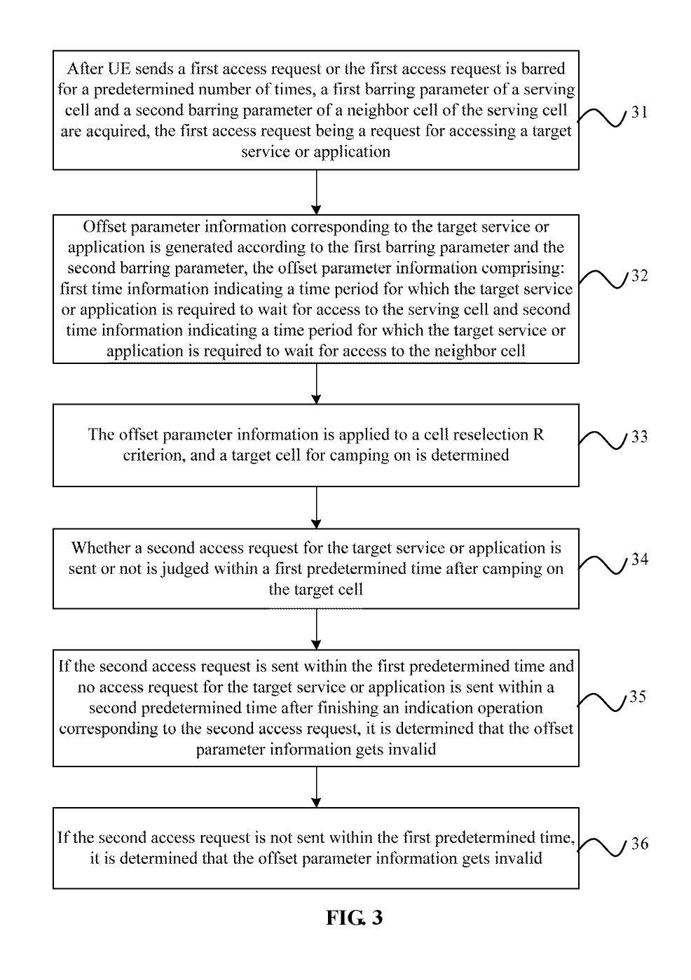

As shown in FIG. 3, a cell reselection method of the embodiment of the disclosure comprises the following steps.

In 31, after UE sends a first access request or the first access request is barred for a predetermined number of times, a first barring parameter of a serving cell and a second barring parameter of a neighbor cell of the serving cell are acquired, the first access request being a request for accessing a target service or application.

In 32, offset parameter information corresponding to the target service or application is generated according to the first barring parameter and the second barring parameter, the offset parameter information including: first time information indicating a time period for which the target service or application is required to wait for access to the serving cell and second time information indicating a time period for which the target service or application is required to wait for access to the neighbor cell.

In 33, the offset parameter information is applied to a cell reselection R criterion, and a target cell to be camped on is determined.

In 34, whether a second access request for the target service or application is sent or not is judged within a first predetermined time after camping on the target cell.

In 35, if the second access request is sent within the first predetermined time and no access request for the target service or application is sent within a second predetermined time after finishing an indication operation corresponding to the second access request, it is determined that the offset parameter information gets invalid.

Specifically, after camping on the target cell, a timer T1 is set, the UE initiates the access request for the original service or application when T1 is not expired and returns to an idle state when the service is finished; a timer T2 is then set, and if the service is not initiated anymore when T2 is expired, the offset parameter gets invalid.

In 36, if the second access request is not sent within the first predetermined time, it is determined that the offset parameter information gets invalid.

Specifically, after camping on the target cell, the timer T1 is set, and if the UE does not initiate the access request for the original service or application when T1 is expired, the offset parameter information gets invalid. In the embodiment of the disclosure, the timers T1 and T2 are set, so that the parameter is time-sensitive, and an access success rate of the target service or application may be improved more accurately.

### Third Embodiment

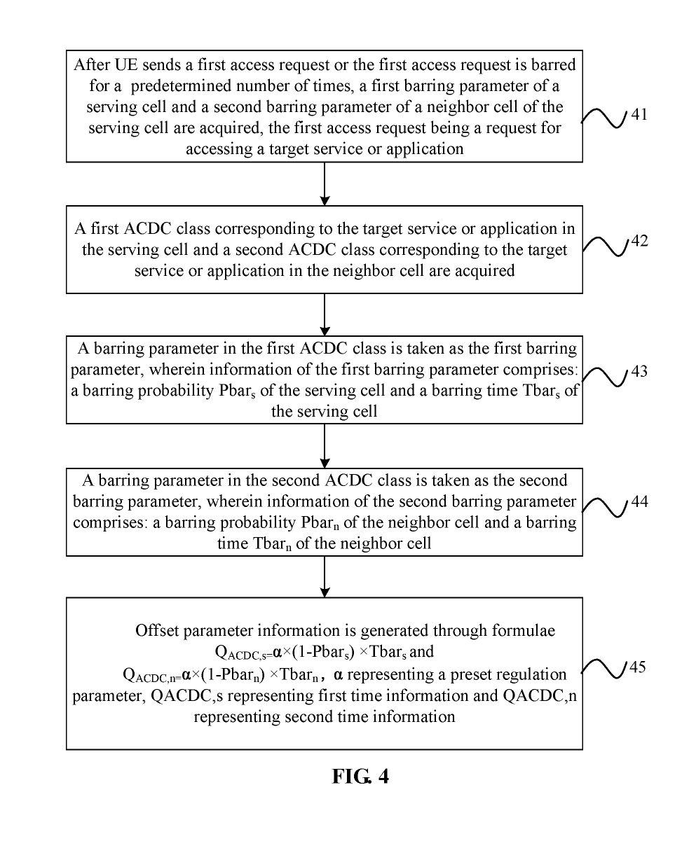

As shown in FIG. 4, a cell reselection method of the embodiment of the disclosure comprises the following steps.

In 41, after UE sends a first access request or the first access request is barred for a predetermined number of times, a first barring parameter of a serving cell and a second barring parameter of a neighbor cell of the serving cell are acquired, the first access request being a request for accessing a target service or application.

In 42, a first ACDC class corresponding to the target service or application in the serving cell and a second ACDC class corresponding to the target service or application in the neighbor cell are acquired.

In 43, a barring parameter in the first ACDC class is taken as the first barring parameter, wherein information of the first barring parameter comprises: a barring probability Pbarₛ of the serving cell and a barring time Tbarₛ of the serving cell.

In 44, a barring parameter in the second ACDC class is taken as the second barring parameter, wherein information of the second barring parameter comprises: a barring probability Pbarₙ of the neighbor cell and a barring time Tbarₙ of the neighbor cell.

In 45, offset parameter information is generated through formulae Q_{ACDC,s}=α×(1−Pbarₛ)×Tbarₛ and Q_{ACDC,n}=α×(1−Pbarₙ)×Tbarₙ, α representing a preset adjustment parameter, Q_{ACDC,s} representing first time information and Q_{ACDC,n} representing second time information. Here, α is for adjusting a value of Q_{ACDC} to make it work appropriately in an R criterion, and the parameter α may be changed according to a network configuration.

After the first time information and the second time information are obtained, a value of R of the serving cell is acquired through a formula Rₛ=Q_{meas,s}+Q_{Hyst}−Q_{offsettemp}−Q_{ACDC,s}, where Rₛ represents the value of R of the serving cell, Q_{mean,s} represents RSRP for cell reselection, Q_{Hyst} represents a reselection hysteresis parameter of the serving cell, Q_{offsettemp} represents a new offset parameter in the cell reselection R criterion, and Q_{ACDC,s} represents the first time information;

a value of R of the neighbor cell is acquired through a formula Rₙ=Q_{meas,n}−Q_{offset}−Q_{offsettemp}−Q_{ACDC,n} where Rₙ represents the value of R of the neighbor cell, Q_{mean,n} represents the RSRP for cell reselection, Q_{offset} represents an offset value of the neighbor cell, Q_{offsettemp} represents the new offset parameter in the cell reselection R criterion, and Q_{ACDC,n} represents the second time information; and

the cell with a maximum value of R is selected from the serving cell and the neighbor cell as a target cell.

In the embodiment, the offset parameter information is generated by virtue of the barring parameters in the ACDC classes corresponding to the service or the application. If the UE initiates a request for accessing an application A, the UE looks up that the application A belongs to the ACDC class 2 and barring parameters corresponding to the ACDC class 2 in barring parameters broadcast by a network are a barring probability Pbar and a barring time Tbar, then obtains values of R of the serving cell and the neighbor cell through the abovementioned formulae according to the barring probability Pbar and the barring time Tbar, and finally determines the target cell for camping on according to the values of R.

### Fourth Embodiment

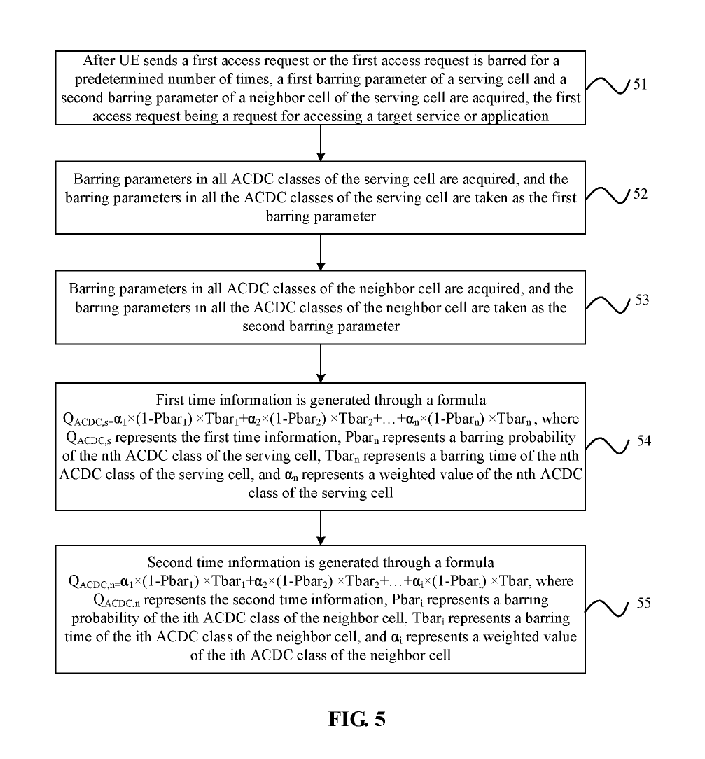

As shown in FIG. 5, a cell reselection method of the embodiment of the disclosure comprises the following steps.

In 51, after UE sends a first access request or the first access request is barred for a predetermined number of times, a first barring parameter of a serving cell and a second barring parameter of a neighbor cell of the serving cell are acquired, the first access request being a request for accessing a target service or application.

In 52, barring parameters in all ACDC classes of the serving cell are acquired, and the barring parameters in all the ACDC classes of the serving cell are taken as the first barring parameter.

In 53, barring parameters in all ACDC classes of the neighbor cell are acquired, and the barring parameters in all the ACDC classes of the neighbor cell are taken as the second barring parameter.

In 54, first time information is generated through a formula Q_{ACDC, s}=α×(1−Pbar₁)×Tbar₁+α₂×(1−Pbar₂)×Tbar₂+ . . . +αₙ×(1−Pbarₙ)×Tbarₙ, where Q_{ACDC,s} represents the first time information, Pbarₙ represents a barring probability of the nth ACDC class of the serving cell, Tbarₙ represents a barring time of the nth ACDC class of the serving cell, and αₙ represents a weighted value of the nth ACDC class of the serving cell.

In 55, second time information is generated through a formula Q_{ACDC, n}=α₁×(1−Pbar₁)×Tbar₁+α₂×(1−Pbar₂)×Tbar₂+ . . . +α₁×(1−Pbarᵢ)×Tbarᵢ, where Q_{ACDC,n} represents the second time information, Pbarᵢ represents a barring probability of the ith ACDC class of the neighbor cell, Tbarᵢ represents a barring time of the ith ACDC class of the neighbor cell, and αᵢ represents a weighted value of the ith ACDC class of the neighbor cell.

Here, αᵢ represents the weighted value of the ith ACDC class of the neighbor cell. For example, in a statistical time, the UE has more applications or services of an ACDC class 2, and a value of α₂ should be appropriately increased.

After the first time information and the second time information are obtained, a value of R of the serving cell is acquired through a formula Rₛ=Q_{meas,s}+Q_{Hyst}−Q_{offsettemp}−Q_{ACDC,s}, where Rₛ represents the value of R of the serving cell, Q_{mean,s} represents RSRP for cell reselection, Q_{Hyst} represents a reselection hysteresis parameter of the serving cell, Q_{offsettemp} represents a new offset parameter in the cell reselection R criterion, and Q_{ACDC,s} represents the first time information;

a value of R of the neighbor cell is acquired through a formula Rₙ=Q_{meas,n}−Q_{offset}−Q_{offsettemp}−Q_{ACDC,n}, where Rₙ represents the value of R of the neighbor cell, Q_{mean,n} represents the RSRP for cell reselection, Q_{offset} represents an offset value of the neighbor cell, Q_{offsettemp} represents the new offset parameter in the cell reselection R criterion, and Q_{ACDC,n} represents the second time information; and

the cell with a maximum value of R is selected from the serving cell and the neighbor cell as a target cell.

In the embodiment, the offset parameter information is generated by virtue of the barring parameters in multiple ACDC classes broadcast by a network. For example, the barring parameters are read from the broadcast, i.e., a barring parameter (Pbar₁, Tbar₁) of an ACDC class 1, a barring parameter (Pbar₂, Tbar₂) of an ACDC class 2 and a barring parameter (Pbar₃, Tbar₃) of an ACDC class 3, then the values of R of the serving cell and the neighbor cell are obtained through the abovementioned formulae according to the barring probability Pbar and the barring time Tbar, and the target cell for camping on is finally determined according to the R values.

The technical solutions of generating the offset parameter information by virtue of the barring parameters in the ACDC classes corresponding to the service or the application and generating the offset parameter information by virtue of the barring parameters in the multiple ACDC classes broadcast by the network are introduced in the third embodiment and the fourth embodiment respectively, and of course, in the embodiments of the disclosure, the offset parameter information may also be generated by virtue of other rules according to the ACDC barring parameters, which will not be listed herein one by one for description.

### Fifth Embodiment

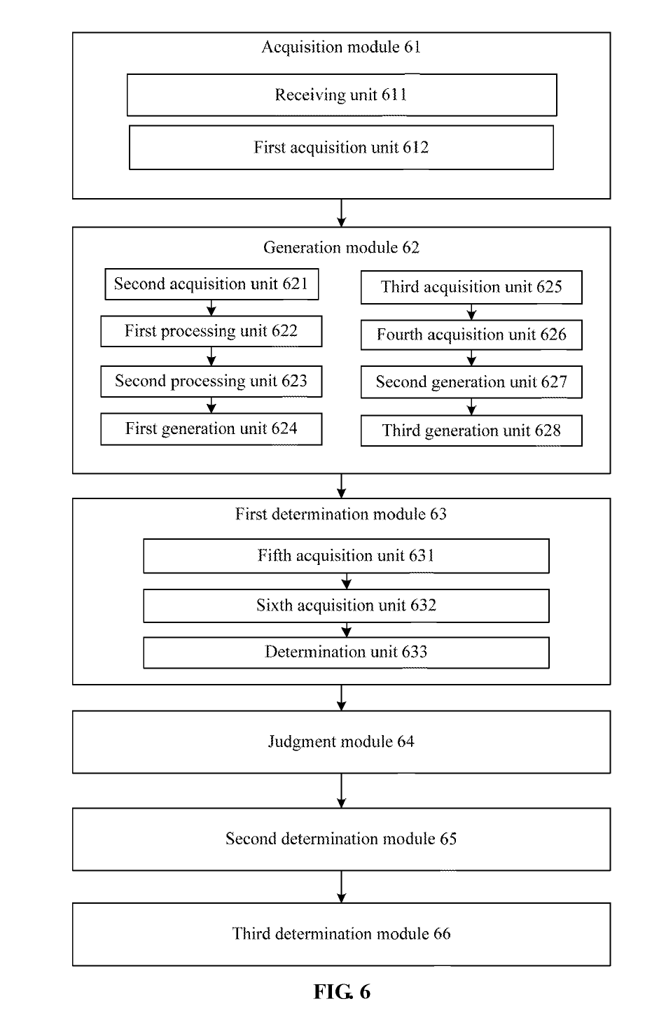

As shown in FIG. 6, the embodiment of the disclosure further provides a cell reselection device, which comprises:

an acquisition module 61, configured to, after UE sends a first access request or the first access request is barred for a predetermined number of times, acquire a first barring parameter of a serving cell and a second barring parameter of a neighbor cell of the serving cell, the first access request being a request for accessing a target service or application;

a generation module 62, configured to generate offset parameter information corresponding to the target service or application according to the first barring parameter and the second barring parameter, the offset parameter information comprising: first time information indicating a time period for which the target service or application is required to wait for access to the serving cell and second time information indicating a time period for which the target service or application is required to wait for access to the neighbor cell; and

a first determination module 63, configured to apply the offset parameter information to a cell reselection R criterion and determine a target cell for camping on.

Furthermore, the cell reselection device of the embodiment of the disclosure further comprises:

a judgment module 64, configured to judge whether a second access request for the target service or application is sent or not within a first predetermined time after camping on the target cell;

a second determination module 65, configured to, if the second access request is sent within the first predetermined time and no access request for the target service or application is sent within a second predetermined time after finishing an indication operation corresponding to the second access request, determine that the offset parameter information gets invalid; and

a third determination module 66, configured to, if the second access request is not sent within the first predetermined time, determine that the offset parameter information gets invalid.

Furthermore, the acquisition module 61 comprises:

a receiving unit 611, configured to receive the second barring parameter, broadcast by a base station of which the serving cell is under coverage, of the neighbor cell, here, the second barring parameter is an ACDC barring parameter of the neighbor cell; or,

a first acquisition unit 612, configured to acquire an MIB message of the neighbor cell, and perform analysis and processing on an SIB message according to the MIB message to obtain the second barring parameter of the neighbor cell, herein the second barring parameter is the ACDC barring parameter of the neighbor cell.

Furthermore, the generation module 62 comprises:

a second acquisition unit 621, configured to acquire first ACDC class corresponding to the target service or application in the serving cell and a second ACDC class corresponding to the target service or application in the neighbor cell;

a first processing unit 622, configured to take a barring parameter in the first ACDC class as the first barring parameter, herein information of the first barring parameter comprises: a barring probability Pbarₛ of the serving cell and a barring time Tbarₛ of the serving cell;

a second processing unit 623, configured to take a barring parameter in the second ACDC class as the second barring parameter, herein information of the second barring parameter comprises: a barring probability Pbarₙ of the neighbor cell and a barring time Tbarₙ of the neighbor cell; and

a first generation unit 624, configured to generate the offset parameter information through formulae Q_{ACDC,s}=α×(1−Pbarₛ)×Tbarₛ and Q_{ACDC,n}=α×(1−Pbarₙ)×Tbarₙ, α representing a preset adjustment parameter, Q_{ACDC,s} representing the first time information and Q_{ACDC,n} representing the second time information.

Furthermore, the generation module 62 further comprises:

a third acquisition unit 625, configured to acquire barring parameters in all ACDC classes of the serving cell, and take the barring parameters in all the ACDC classes of the serving cell as the first barring parameter;

a fourth acquisition unit 626, configured to acquire barring parameters in all ACDC classes of the neighbor cell, and take the barring parameters in all the ACDC classes of the neighbor cell as the second barring parameter;

a second generation unit 627, configured to generate the first time information through a formula Q_{ACDC, s}=α₁×(1−Pbar₁)×Tbar₁+α₂×(1−Pbar₂)×Tbar₂+ . . . +αₙ×(1−Pbarₙ)×Tbarₙ, where Q_{ACDC,s} represents the first time information, Pbarₙ represents a barring probability of the nth ACDC class of the serving cell, Tbarₙ represents a barring time of the nth ACDC class of the serving cell, and αₙ represents a weighted value of the nth ACDC class of the serving cell; and

a third generation unit 628, configured to generate the second time information through a formula Q_{ACDC, n}=α₁×(1−Pbar₁)×Tbar₁+α₂×(1−Pbar₂)×Tbar₂+ . . . +α₁×(1−Pbarᵢ)×Tbarᵢ, where Q_{ACDC,n} represents the second time information, Pbarᵢ represents a barring probability of the ith ACDC class of the neighbor cell, Tbarᵢ represents a barring time of the ith ACDC class of the neighbor cell, and αᵢ represents a weighted value of the ith ACDC class of the neighbor cell.

Furthermore, the first determination module 63 comprises:

a fifth acquisition unit 631, configured to acquire a value of R of the serving cell through a formula Rₛ=Q_{meas,s}+Q_{Hyst}−Q_{offsettemp}−Q_{ACDC,s} where Rₛ represents the value of R of the serving cell, Q_{mean,s} represents RSRP for cell reselection, Q_{Hyst} represents a reselection hysteresis parameter of the serving cell, Q_{offsettemp} represents a new offset parameter in the cell reselection R criterion, and Q_{ACDC,s} represents the first time information;

a sixth acquisition unit 632, configured to acquire a value of R of the neighbor cell through a formula Rₙ=Q_{meas,n}−Q_{offset}−Q_{offsettemp}−Q_{ACDC,n}, where Rₙ represents the value of R of the neighbor cell, Q_{mean,n} represents the RSRP for cell reselection, Q_{offset} represents an offset value of the neighbor cell, Q_{offsettemp} represents the new offset parameter in the cell reselection R criterion, and Q_{ACDC,n} represents the second time information; and

a determination unit 633, configured to select the cell with a maximum value of R from the serving cell and the neighbor cell as the target cell.

It is important to note that the device is a device corresponding to the abovementioned method embodiment, all implementation modes in the method embodiment are applied to the embodiment of the device, and the same technical effect may also be achieved.

According to the cell reselection method and device of the embodiments of the disclosure, after the UE sends the first access request or the first access request is barred for a predetermined number of times, the first barring parameter of the serving cell and the second barring parameter of the neighbor cell of the serving cell are acquired; the offset parameter information corresponding to the target service or application is generated according to the first barring parameter and the second barring parameter; and the offset parameter information is applied to the cell reselection R criterion, and the target cell for camping on is determined. According to the embodiments of the disclosure, the offset parameter information is applied to the cell reselection R criterion for reselection of the cell suitable for the target service or application, so that a waiting time for access to the target service or application is reduced, and an access success rate of the target service or application is improved.

The above is the optional implementation mode of the disclosure. It should be pointed out that those skilled in the art may further make a plurality of improvements and embellishments without departing from the principle of the disclosure and these improvements and embellishments shall also fall within the scope of protection of the disclosure.

1. A cell reselection method, applied to User Equipment (UE), wherein the cell reselection method comprises:
after the UE sends a first access request or the first access request is barred for a predetermined number of times, acquiring a first barring parameter of a serving cell and a second barring parameter of a neighbor cell of the serving cell, the first access request being a request for accessing a target service or application;
generating offset parameter information corresponding to the target service or application according to the first barring parameter and the second barring parameter, the offset parameter information comprising: first time information indicating a time period for which the target service or application is required to wait for access to the serving cell and second time information indicating a time period for which the target service or application is required to wait for access to the neighbor cell; and
applying the offset parameter information to a cell reselection R criterion, and determining a target cell for camping on.

2. The cell reselection method according to claim 1, after applying the offset parameter information to the cell reselection R criterion and determining the target cell for camping on, the cell reselection method further comprising:
judging whether a second access request for the target service or application is sent or not within a first predetermined time after camping on the target cell;
if the second access request is sent within the first predetermined time and no access request for the target service or application is sent within a second predetermined time after finishing an indication operation corresponding to the second access request, determining that the offset parameter information gets invalid; and
if the second access request is not sent within the first predetermined time, determining that the offset parameter information gets invalid.

3. The cell reselection method according to claim 1, wherein acquiring the second barring parameter of the neighbor cell of the serving cell comprises:
receiving the second barring parameter, broadcast by the serving cell, of the neighbor cell, wherein the second barring parameter is an access control barring parameter of the neighbor cell; or,
acquiring a Master Information Block (MIB) message of the neighbor cell, and performing analysis and processing on a System Information Block (SIB) message according to the MIB message to obtain the second barring parameter of the neighbor cell, wherein the second barring parameter is the access control barring parameter of the neighbor cell.

4. The cell reselection method according to claim 1, wherein generating the offset parameter information corresponding to the target service or application according to the first barring parameter and the second barring parameter comprises:
acquiring a first access control class corresponding to the target service or application in the serving cell and a second access control class corresponding to the target service or application in the neighbor cell;
taking a barring parameter in the first access control class as the first barring parameter, wherein information of the first barring parameter comprises: a barring probability Pbarₛ of the serving cell and a barring time Tbarₛ of the serving cell;
taking a barring parameter in the second access control class as the second barring parameter, wherein information of the second barring parameter comprises: a barring probability Pbarₙ of the neighbor cell and a barring time Tbarₙ of the neighbor cell; and
generating the offset parameter information through formulae Q_{ACDC,s}=α×(1−Pbarₛ)×Tbarₛ and Q_{ACDC,n}=α×(1−Pbarₙ)×Tbarₙ, α representing a preset adjustment parameter, Q_{ACDC,s} representing the first time information and Q_{ACDC,n} representing the second time information.

5. The cell reselection method according to claim 1, wherein generating the offset parameter information corresponding to the target service or application according to the first barring parameter and the second barring parameter comprises:
acquiring barring parameters in all access control classes of the serving cell, and taking the barring parameters in all the access control classes of the serving cell as the first barring parameter;
acquiring barring parameters in all access control classes of the neighbor cell, and taking the barring parameters in all the access control classes of the neighbor cell as the second barring parameter;
generating the first time information through a formula Q_{ACDC, s}=α₁×(1−Pbar₁)×Tbar₁+α₂×(1−Pbar₂)×Tbar₂+ . . . +αₙ×(1−Pbarₙ)×Tbarₙ, where Q_{ACDC,s} represents the first time information, Pbarₙ represents a barring probability of the nth access control class of the serving cell, Tbarₙ represents a barring time of the nth access control class of the serving cell, and αₙ represents a weighted value of the nth access control class of the serving cell; and
generating the second time information through a formula Q_{ACDC, n}=α₁×(1−Pbar₁)×Tbar₁+α₂×(1−Pbar₂)×Tbar₂+ . . . +αᵢ×(1−Pbarᵢ)×Tbarᵢ, where Q_{ACDC,n} represents the second time information, Pbarᵢ represents a barring probability of the ith access control class of the neighbor cell, Tbarᵢ represents a barring time of the ith access control class of the neighbor cell, and αᵢ represents a weighted value of the ith access control class of the neighbor cell.

6. The cell reselection method according to claim 4, wherein applying the offset parameter information to the cell reselection R criterion and determining the target cell for camping on comprises:
acquiring a value of R of the serving cell through a formula Rₛ=Q_{meas,s}+Q_{Hyst}−Q_{offsettemp}−Q_{ACDC,s} where Rₛ represents the value of R of the serving cell, Q_{mean,s} represents Reference Signal Receiving Power (RSRP) for cell reselection, Q_{Hyst} represents a reselection hysteresis parameter of the serving cell, Q_{offsettemp} represents a new offset parameter in the cell reselection R criterion, and Q_{ACDC,s} represents the first time information;
acquiring a value of R of the neighbor cell through a formula Rₙ=Q_{meas,n}−Q_{offset}−Q_{offsettemp}−Q_{ACDC,n}, where Rₙ represents the value of R of the neighbor cell, Q_{mean,n} represents the RSRP for cell reselection, Q_{offset} represents an offset value of the neighbor cell, Q_{offsettemp} represents the new offset parameter in the cell reselection R criterion, and Q_{ACDC,n} represents the second time information; and
selecting a cell with a maximum value of R from the serving cell and the neighbor cell as the target cell.

7. A cell reselection device, applied to User Equipment (UE), wherein the cell reselection device comprises:
an acquisition module, configured to, after the UE sends a first access request or the first access request is barred for a predetermined number of times, acquire a first barring parameter of a serving cell and a second barring parameter of a neighbor cell of the serving cell, the first access request being a request for accessing a target service or application;
a generation module, configured to generate offset parameter information corresponding to the target service or application according to the first barring parameter and the second barring parameter, the offset parameter information comprising: first time information indicating a time period for which the target service or application is required to wait for access to the serving cell and second time information indicating a time period for which the target service or application is required to wait for access to the neighbor cell; and
a first determination module, configured to apply the offset parameter information to a cell reselection R criterion and determine a target cell for camping on.

8. The cell reselection device according to claim 7, further comprising:
a judgment module, configured to judge whether a second access request for the target service or application is sent or not within a first predetermined time after camping on the target cell;
a second determination module, configured to, if the second access request is sent within the first predetermined time and no access request for the target service or application is sent within a second predetermined time after finishing an indication operation corresponding to the second access request, determine that the offset parameter information gets invalid; and
a third determination module, configured to, if the second access request is not sent within the first predetermined time, determine that the offset parameter information gets invalid.

9. The cell reselection device according to claim 7, wherein the acquisition module comprises:
a receiving unit, configured to receive the second barring parameter, broadcast by the serving cell, of the neighbor cell, wherein the second barring parameter is an access control barring parameter of the neighbor cell; or,
a first acquisition unit, configured to acquire a Master Information Block (MIB) message of the neighbor cell, and perform analysis and processing on a System Information Block (SIB) message according to the MIB message to obtain the second barring parameter of the neighbor cell, wherein the second barring parameter is the access control barring parameter of the neighbor cell.

10. The cell reselection device according to claim 7, wherein the generation module comprises:
a second acquisition unit, configured to acquire first access control class corresponding to the target service or application in the serving cell and a second access control class corresponding to the target service or application in the neighbor cell;
a first processing unit, configured to take a barring parameter in the first access control class as the first barring parameter, wherein information of the first barring parameter comprises: a barring probability Pbarₛ of the serving cell and a barring time Tbarₛ of the serving cell;
a second processing unit, configured to take a barring parameter in the second access control class as the second barring parameter, wherein information of the second barring parameter comprises: a barring probability Pbarₙ of the neighbor cell and a barring time Tbarₙ of the neighbor cell; and
a first generation unit, configured to generate the offset parameter information through formulae Q_{ACDC,s}=α×(1−Pbarₛ)×Tbarₛ and Q_{ACDC,n}=α×(1−Pbarₙ)×Tbarₙ, α representing a preset adjustment parameter, Q_{ACDC,s} representing the first time information and Q_{ACDC,n} representing the second time information.

11. The cell reselection device according to claim 7, wherein the generation module further comprises:
a third acquisition unit, configured to acquire barring parameters in all access control classes of the serving cell, and take the barring parameters in all the access control classes of the serving cell as the first barring parameter;
a fourth acquisition unit, configured to acquire barring parameters in all access control classes of the neighbor cell, and take the barring parameters in all the access control classes of the neighbor cell as the second barring parameter;
a second generation unit, configured to generate the first time information through a formula Q_{ACDC, s}=α₁×(1−Pbar₁)×Tbar₁+α₂×(1−Pbar₂)×Tbar₂+ . . . +αₙ×(1−Pbarₙ)×Tbarₙ, where Q_{ACDC,s} represents the first time information, Pbarₙ represents a barring probability of the nth access control class of the serving cell, Tbarₙ represents a barring time of the nth access control class of the serving cell, and αₙ represents a weighted value of the nth access control class of the serving cell; and
a third generation unit, configured to generate the second time information through a formula Q_{ACDC, n}=α₁×(1−Pbar₁)×Tbar₁+α₂×(1−Pbar₂)×Tbar₂+ . . . +αᵢ×(1−Pbarᵢ)×Tbarᵢ, where Q_{ACDC,n} represents the second time information, Pbarᵢ represents a barring probability of the ith access control class of the neighbor cell, Tbarᵢ represents a barring time of the ith access control class of the neighbor cell, and αᵢ represents a weighted value of the ith access control class of the neighbor cell.

12. The cell reselection device according to claim 10, wherein the first determination module comprises:
a fifth acquisition unit, configured to acquire a value of R of the serving cell through a formula Rₛ=Q_{meas,s}+Q_{Hyst}−Q_{offsettemp}−Q_{ACDC,s}, where Rₛ represents the value of R of the serving cell, Q_{mean,s} represents Reference Signal Receiving Power (RSRP) for cell reselection, Q_{Hyst} represents a reselection hysteresis parameter of the serving cell, Q_{offsettemp} represents a new offset parameter in the cell reselection R criterion, and Q_{ACDC,s} represents the first time information;
a sixth acquisition unit, configured to acquire a value of R of the neighbor cell through a formula Rₙ=Q_{meas,n}−Q_{offset}−Q_{offsettemp}−Q_{ACDC,n}, where Rₙ represents the value of R of the neighbor cell, Q_{mean,n} represents the RSRP for cell reselection, Q_{offset} represents an offset value of the neighbor cell, Q_{offsettemp} represents the new offset parameter in the cell reselection R criterion, and Q_{ACDC,n} represents the second time information; and
a determination unit, configured to select a cell with a maximum value of R from the serving cell and the neighbor cell as the target cell.

13. The cell reselection method according to claim 5, wherein applying the offset parameter information to the cell reselection R criterion and determining the target cell for camping on comprises:
acquiring a value of R of the serving cell through a formula Rₛ=Q_{meas,s}+Q_{Hyst}−Q_{offsettemp}−Q_{ACDC,s}, where Rₛ represents the value of R of the serving cell, Q_{mean,s} represents Reference Signal Receiving Power (RSRP) for cell reselection, Q_{Hyst} represents a reselection hysteresis parameter of the serving cell, Q_{offsettemp} represents a new offset parameter in the cell reselection R criterion, and Q_{ACDC,s} represents the first time information;
acquiring a value of R of the neighbor cell through a formula Rₙ=Q_{meas,n}−Q_{offset}−Q_{offsettemp}−Q_{ACDC,n}, where Rₙ represents the value of R of the neighbor cell, Q_{mean,n} represents the RSRP for cell reselection, Q_{offset} represents an offset value of the neighbor cell, Q_{offsettemp} represents the new offset parameter in the cell reselection R criterion, and Q_{ACDC,n} represents the second time information; and
selecting a cell with a maximum value of R from the serving cell and the neighbor cell as the target cell.

14. The cell reselection device according to claim 11, wherein the first determination module comprises:
a fifth acquisition unit, configured to acquire a value of R of the serving cell through a formula Rₛ=Q_{meas,s}+Q_{Hyst}−Q_{offsettemp}−Q_{ACDC,s}, where Rₛ represents the value of R of the serving cell, Q_{mean,s} represents Reference Signal Receiving Power (RSRP) for cell reselection, Q_{Hyst} represents a reselection hysteresis parameter of the serving cell, Q_{offsettemp} represents a new offset parameter in the cell reselection R criterion, and Q_{ACDC,s} represents the first time information;
a sixth acquisition unit, configured to acquire a value of R of the neighbor cell through a formula Rₙ=Q_{meas,n}−Q_{offset}−Q_{offsettemp}−Q_{ACDC,n}, where Rₙ represents the value of R of the neighbor cell, Q_{mean,n} represents the RSRP for cell reselection, Q_{offset} represents an offset value of the neighbor cell, Q_{offsettemp} represents the new offset parameter in the cell reselection R criterion, and Q_{ACDC,n} represents the second time information; and
a determination unit, configured to select a cell with a maximum value of R from the serving cell and the neighbor cell as the target cell.
